(19) United States
(12) Patent Application Publication
(10) Pub. No.: US 2018/0294927 A1
(43) Pub. Date: Oct. 11, 2018

(54) USER TERMINAL, RADIO BASE STATION AND RADIO COMMUNICATION METHOD

(71) Applicant: NTT DOCOMO, INC., Tokyo (JP)

(72) Inventors: Kazuaki Takeda, Tokyo (JP); Satoshi Nagata, Tokyo (JP); Qin Mu, Beijing (CN); Liu Liu, Beijing (CN); Huiling Jiang, Beijing (CN)

(73) Assignee: NTT DOCOMO, INC., Tokyo (JP)

(21) Appl. No.: 15/767,685

(22) PCT Filed: Nov. 4, 2016
(86) PCT No.: PCT/JP2016/082771

§ 371 Date: Apr. 12, 2018

(30) Foreign Application Priority Data
Nov. 5, 2015 (JP) 2015-217987

(51) Int. Cl. H04L 1/18; H04W 72/04

(52) U.S. Cl. CPC H04L 1/1861; H04W 72/0413; H04W 72/042

(57) ABSTRACT

The present invention is designed so that HARQ-ACKs can be transmitted adequately in future radio communication systems. According to one aspect of the present invention, a user terminal has a receiving section that receives a DL signal, and a control section that controls transmission of a delivery acknowledgement signal in response to the DL signal. The receiving section receives information on whether or not transmission of the delivery acknowledgement signal is possible in higher layer signaling and/or in downlink control information, and the control section controls whether or not the delivery acknowledgement signal can be transmitted based on the information on whether or not transmission of the delivery acknowledgement signal is possible.

### TECHNICAL FIELD

The present invention relates to a user terminal, a radio base station and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). Also, successor systems of LTE (referred to as, for example, “LTE-A” (LTE-Advanced), “FRA” (Future Radio Access), “4G,” “5G,” and so on) are under study for the purpose of achieving further broadbandization and increased speed beyond LTE.

Now, accompanying the cost reduction of communication devices in recent years, active development is in progress in the field of technology related to machine-to-machine communication (M2M) to implement automatic control of network-connected devices and allow these devices to communicate with each other without involving people. In particular, 3GPP (3rd Generation Partnership Project) is promoting the standardization of MTC (Machine-Type Communication) for cellular systems for machine-to-machine communication, among all M2M technologies (see non-patent literature 2). User terminals for MTC (MTC UE (User Equipment)) are being studied for use in a wide range of fields such as, for example, electric meters, gas meters, vending machines, vehicles and other industrial equipment.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall Description; Stage 2”

Non-Patent Literature 2: 3GPP TS 36.888 “Study on provision of low-cost Machine-Type Communications (MTC) User Equipments (UEs) based on LTE (Release 12)”

### SUMMARY OF INVENTION

### Technical Problem

From the perspective of reducing the cost and improving the coverage area in cellular systems, in MTC, user terminals for MTC (LC (Low-Cost) MTC UEs) that can be implemented in simple hardware structures have been increasingly in demand. For these LC-MTC UEs, a communication scheme to allow LTE communication in a very narrow band is under study (which may be referred to as, for example, “NB-IoT” (Narrow Band Internet of Things), “NB-LTE” (Narrow Band LTE),” “NB cellular IoT” (Narrow Band cellular Internet of Things), “clean slate,” and so on). Note that “NB-IoT” mentioned hereinafter will include above “NB-LTE,” “NB cellular IoT,”“clean slate” and so on.

User terminals that communicate in NB-IoT (hereinafter referred to as “NB-IoT terminals”) are under study as user terminals having the functions to transmit/receive in a narrower band (for example, 180 kHz) than the minimum system bandwidth (1.4 MHz) that is supported in existing LTE systems.

Now, in existing LTE systems (LTE Rel. 8 to 12), hybrid automatic repeat request (HARQ: Hybrid Automatic Repeat reQuest) is supported in order to reduce the degradation of communication quality due to signal reception failures in wireless communication between a user terminal (UE) and a radio base station (eNB). In HARQ, depending on the reception result of data, the user terminal (or the radio base station) feeds back a delivery acknowledgment signal (HARQ-ACK) for the data, and the radio base station (or the user terminal) controls data retransmission based on the HARQ-ACK that is fed back.

In this manner, by applying hybrid automatic repeat request, it is possible to effectively reduce the degradation of the communication quality of wireless communication between the user terminal and the radio base station, so that future wireless communication systems might also provide support for HARQ.

However, in future radio communication systems as described above, when HARQ-ACK control (HARQ-ACK mechanism) in existing LTE systems is applied as it is, there is a fear that sufficient communication service cannot be provided.

The present invention has been made in view of the above, and it is therefore an object of the present invention to provide a user terminal, a radio base station and a radio communication method that allow adequate implementation of HARQ control in future radio communication systems.

### Solution to Problem

According to one aspect of the present invention, a user terminal a receiving section that receives a DL signal, and a control section that controls transmission of a delivery acknowledgement signal in response to the DL signal, and, in this user terminal, the receiving section receives information on whether or not transmission of the delivery acknowledgement signal is possible in higher layer signaling and/or in downlink control information, and the control section controls whether or not the delivery acknowledgement signal can be transmitted based on the information on whether or not transmission of the delivery acknowledgement signal is possible.

### Advantageous Effects of Invention

According to the present invention, it is possible to allow adequate implementation of HARQ control in future radio communication systems.

### BRIEF DESCRIPTION OF DRAWINGS

FIG. 1 is a diagram to explain the band for use for NB-IoT terminals;

FIG. 2 is a diagram to illustrate an example of a method of transmitting HARQ-ACKs in existing LTE systems (Rel. 8 to 12);

FIG. 3 is a diagram to illustrate an example of the HARQ-ACK transmission method according to the first example;

FIG. 4 is a diagram to illustrate an example of the HARQ-ACK transmission method according to the first example;

FIG. 5A and FIG. 5B are diagrams to illustrate an example of the HARQ-ACK transmission method according to the first example;

FIG. 6A is a table illustrate a table associating HARQ function on or off to different RNTIs, and FIG. 6B is a diagram to illustrate an exemplary HARQ-ACK transmission method;

FIG. 7A is a diagram to illustrate a table stipulating information on whether or not HARQ-ACK transmission is possible in a DCI bit field, and FIG. 7B is a diagram to illustrate an exemplary HARQ-ACK transmission method;

FIG. 8A is a diagram to illustrate a table stipulating information on whether or not HARQ-ACK transmission is possible in a PUCCH resource-specifying bit field, and FIG. 8B is a diagram to illustrate another exemplary HARQ-ACK transmission method;

FIG. 9A is a diagram to illustrate a table in which different RNTIs are associated with HARQ function on and off commands, and FIG. 9B is a diagram to illustrate another exemplary HARQ-ACK transmission method;

FIG. 10 is a diagram to illustrate a schematic structure of a radio communication system according to an embodiment of the present invention;

FIG. 11 is a diagram to illustrate an example of an overall structure of a radio base station according to an embodiment of the present invention;

FIG. 12 is a diagram to illustrate an example of a functional structure of a radio base station according to an embodiment of the present invention;

FIG. 13 is a diagram to illustrate an example of an overall structure of a user terminal according to an embodiment of the present invention;

FIG. 14 is a diagram to illustrate an example of a functional structure of a user terminal according to an embodiment of the present invention; and

FIG. 15 is a diagram to illustrate an exemplary hardware structure of a radio base station and a user terminal according to an embodiment of the present invention.

### DESCRIPTION OF EMBODIMENTS

Studies are in progress to simplify the hardware structures of NB-IoT terminals at the risk of lowering their processing capabilities. For example, studies are in progress to apply limitations to NB-IoT terminals, in comparison to existing user terminals (LTE terminals), by, for example, lowering the peak rate, limiting the transport block size (TBS), limiting the resource blocks (also referred to as “RBs,” “PRBs” (Physical Resource Blocks) and so on), limiting the RFs (Radio Frequencies) to receive, and so on.

Unlike existing user terminals, in which the system band (for example, 20 MHz (100 PRBs), one component carrier, etc.) is configured as the upper limit band for use, the upper limit band for use for NB-IoT terminals is limited to a predetermined narrow band (for example, 180 kHz, 1 PRB, 1.4 MHz, etc.). Studies are in progress to run such band-limited NB-IoT terminals in LTE/LTE-A system bands, considering the relationship with existing user terminals.

For example, LTE/LTE-A system bands may support frequency-multiplexing of band-limited NB-IoT terminals and band-unlimited existing user terminals. Consequently, NB-IoT terminals may be seen as terminals, in which the maximum band they support is the same band as, or is a partial narrow band in, the minimum system band (for example, 1.4 MHz) supported in existing LTE, or may be seen as terminals which have the functions for transmitting/receiving in the same band as the minimum system band (for example, 1.4 MHz) supported in LTE/LTE-A, or in a narrower band than this minimum system band.

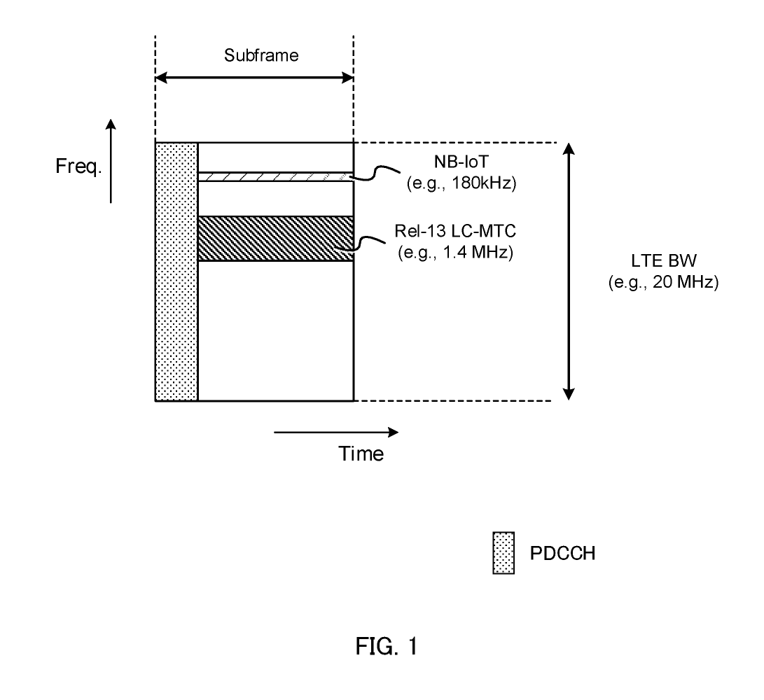

FIG. 1 is a diagram to illustrate an example of the arrangement of a narrow band in a system band. In FIG. 1, a predetermined narrow band (for example, 180 kHz), which is narrower than the minimum system band (1.4 MHz) in LTE systems, is configured in a portion of a system band. This narrow band is equivalent to a frequency band that can be detected by NB-IoT terminals. Note that the minimum system band (1.4 MHz) for LTE systems is also the band for use in LC-MTC in LTE Rel. 13.

Note that it is preferable to employ a structure, in which the frequency location of the narrow band that serves as the band for use by NB-IoT terminals can be changed within the system band. For example, NB-IoT terminals should preferably communicate by using different frequency resources per predetermined period (for example, per subframe). By this means, it is possible to achieve traffic offloading for NB-IoT terminals, achieve a frequency diversity effect, and reduce the decrease of spectral efficiency. Consequently, considering the application of frequency hopping, frequency scheduling and so on, NB-IoT terminals should preferably have an RF re-tuning function.

Note that different frequency bands may be used between the narrow band to use in downlink transmission/reception (DL NB: Downlink Narrow Band) and the narrow band to use in uplink transmission/reception (UL NB: Uplink Narrow Band). Also, the DL NB may be referred to as the “downlink narrow band,” and the UL NB may be referred to as the “uplink narrow band.”

NB-IoT terminals receive downlink control information (DCI) by using a downlink control signal (downlink control channel) that is placed in a narrow band, and this downlink control signal may be referred to as an “EPDCCH” (Enhanced Physical Downlink Control CHannel), may be referred to as an “MPDCCH” (MTC PDCCH), or may be referred to as an “NB-PDCCH.”

Also, NB-IoT terminals receive downlink data by using a downlink data signal (downlink shared channel) that is placed in a narrow band, and this downlink data signal may be referred to as a “PDCCH” (Physical Downlink Shared CHannel), may be referred to as an “MPDSCH” (MTC PDSCH), or may be referred to as an “NB-PDSCH.”

Also, an uplink control signal (uplink control channel) (for example, a PUCCH (Physical Uplink Control CHannel)) and an uplink data signal (uplink shared channel) (for example, a PUSCH (Physical Uplink Shared CHannel)) for NB-IoT terminals may be referred to as an “MPUCCH” (MTC PUCCH), an “MPUSCH” (MTC PUSCH), and an “NB-PUSCH,” respectively. The above channels are by no means limiting, and any channel that is used by NB-IoT terminals may be represented by affixing an “M,” which stands for MTC, an “N,” which stands for NB-IoT, or an “NB,” to a conventional channel used for the same purpose.

Also, it is possible to provide SIBs (System Information Blocks) for NB-IoT UEs, and these SIBs may be referred to as “MTC-SIBs,”“NB-SIBs,” and so on.

Now, in NB-IoT, a study is in progress to use repetitious transmission/receipt, in which the same downlink signal and/or uplink signal are transmitted/received in repetitions over a plurality of subframes, for enhanced coverage. Note that the number of a plurality of subframes in which the same downlink signal and/or uplink signal are transmitted and received is also referred to as “the number of repetitions” (or “repetition number”). Also, the number of repetitions may be represented by the repetition level. This repetition level is also referred to as the “coverage enhancement (CE) level.”

Now, in existing LTE systems (LTE Rel. 8 to 12), hybrid automatic repeat request (HARQ: Hybrid Automatic Repeat reQuest) is supported in order to reduce the degradation of communication quality due to signal reception failures in wireless communication between a user terminal (UE) and a radio base station (eNB).

For example, the user terminal feeds back an delivery acknowledgment signal (also referred to as an “HARQ-ACK,” an “ACK/NACK,” or an “A/N”) based on the reception result of a DL signal/DL channel transmitted from the radio base station. The radio base station controls retransmission and new data transmission based on the delivery acknowledgment signal transmitted from the user terminal (DL HARQ). Also, the radio base station feeds back an delivery acknowledgment signal based on the reception result of a UL signal/UL channel transmitted from the user terminal. The user terminal controls retransmission and new data transmission based on the delivery acknowledgment signal and/or a UL transmission command transmitted from the radio base station (UL HARQ).

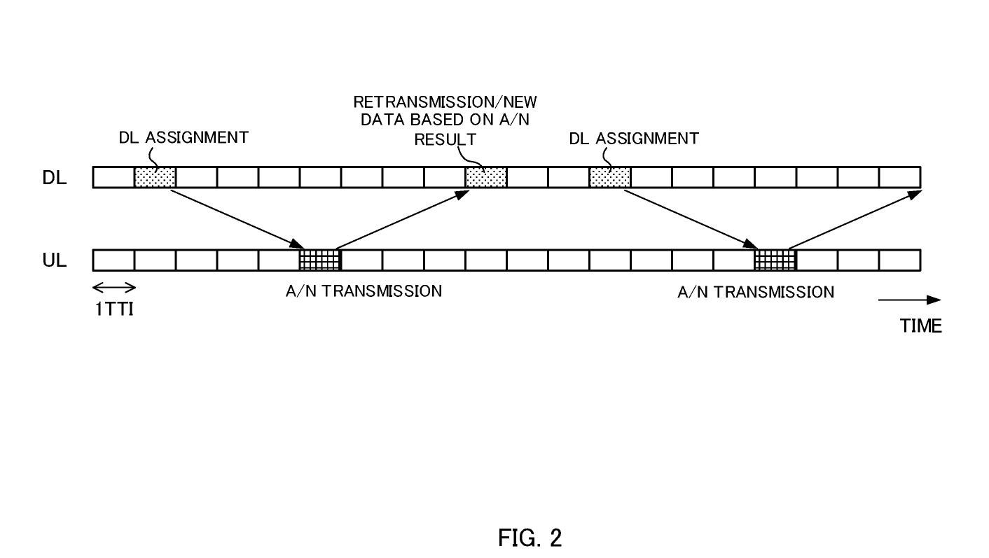

In existing LTE systems, the TTI is set to 1 ms (one subframe) in UL transmission and DL transmission, and the feedback timing of HARQ-ACKs is also controlled in subframe units. In DL HARQ, the user terminal to employ FDD feeds back an HARQ-ACK to the radio base station in the UL subframe 4 ms after a subframe in which a DL signal/DL channel (for example, a PDSCH) is received(see FIG. 2). Also, the radio base station, upon receiving the HARQ-ACK from the user terminal, transmits retransmission data or new data in a DL subframe that comes 4 ms or more later, based on the result of the HARQ-ACK.

As described above, in existing LTE systems, the feedback timing of an HARQ-ACK is controlled to be in a subframe 4 ms after a signal is received, in units of subframes (FDD). In addition, the radio base station and/or the user terminal perform retransmission control based on a predetermined HARQ RTT (Round Trip Time) for signal transmission/reception. RTT refers to the time it takes for a response to be returned after transmitting a signal or data to a communicating party. In existing systems, the minimum time from reception of HARQ-ACK feedback to retransmission is also defined similarly. For example, the radio base station is defined to perform retransmission in a predetermined subframe with a minimum time of 4 ms after receiving an ACK/NACK fed back from the user terminal.

As described above, by applying hybrid automatic repeat request, it is possible to effectively reduce the degradation of communication quality in wireless communication between the user terminal and the radio base station, so that it may be possible to support HARQ-ACK transmission even for NB-IoT terminals. In IoT, efforts to connect all electronic devices such as digital cameras and printers to the Internet are underway. As an example of various service qualities (QoS (Quality Of Service) required by IoT, it may be possible to periodically report status information of electronic devices.

However, when applying existing HARQ in such IoT environment, there is a problem that the overhead increases. Although it may be possible not to apply HARQ in order to reduce the overhead, it is preferable to apply HARQ in certain cases, depending on the purpose of communication (for example, when issuing an emergency alert).

Therefore, the present inventors have paid attention to the fact that HARQ does not necessarily have to be employed in NB-IoT terminals at all times, and come up with the idea of controlling whether or not HARQ-ACKs can be transmitted (HARQ-ACK transmission is permitted) by dynamically or semi-statically controlling whether or not to employ HARQ in the user terminal. To be more specific, as one embodiment of the present invention, the present inventors have come up with the idea of controlling whether or not HARQ-ACKs can be transmitted based on information on whether or not HARQ-ACK transmission is possible. For example, the user terminal can control whether or not it is possible to transmit (transmit or skip) an HARQ-ACK in response to DL transmission based on information on whether or not HARQ-ACK transmission is possible, which is transmitted from the radio base station.

In this way, by controlling whether or not HARQ-ACKs can be transmitted based on information on whether or not HARQ-ACK transmission is possible, it is possible to reduce the overhead and implement adequate HARQ-ACK control in a network environment in which the band for use is limited to a predetermined narrow band, as in NB-IoT.

Now, the radio communication method according to an embodiment of the present invention will be described. In the following description, an NB-IoT terminal will be exemplified as a user terminal that communicates with a radio base station, but the present invention is not limited to this. This embodiment can be applied to any user terminal that performs HARQ-ACK transmission. Although the following embodiments will be described assuming that the band for use for NB-IoT terminals is limited to a band of 180 kHz (one resource block (PRB)), which is narrower than the minimum system bandwidth (1.4 MHz) of existing LTE systems, the application of the present invention is not limited to this. For example, the following embodiments are equally applicable to NB-IoT terminals limited to the same band as the minimum system bandwidth (1.4 MHz) of existing LTE systems, and NB-IoT terminals limited to using a narrower band than 180 kHz.

### First Example

In the first example, a case where the user terminal controls whether or not HARQ-ACKs can be transmitted (HARQ function on/off) based at least on information reported by higher layer signaling will be described.

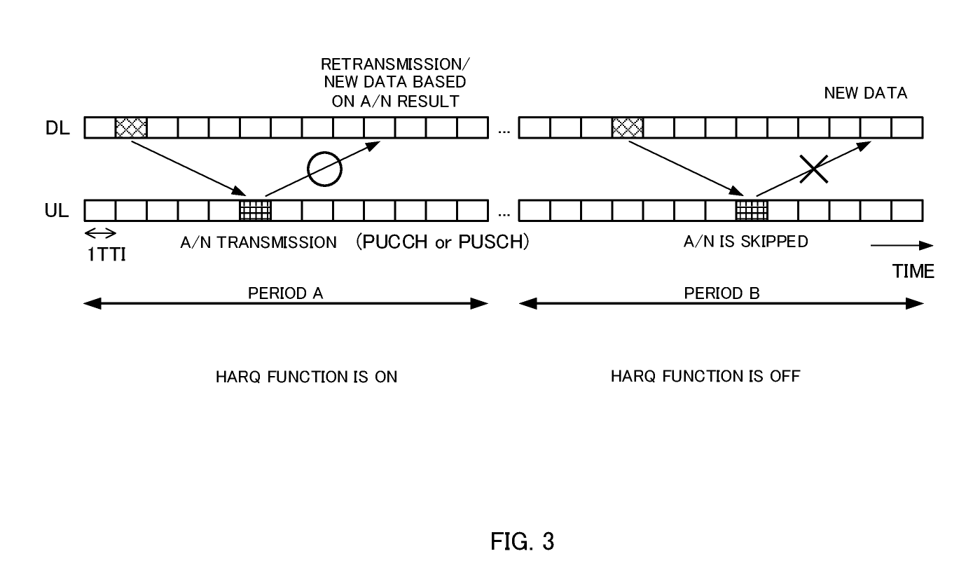

FIG. 3 illustrates an example of HARQ control in the case of controlling on/off of the HARQ function of the user terminal is controlled by using higher layer signaling (for example, RRC signaling, broadcast information, etc.). In the example of FIG. 3, the user terminal receives information about whether the HARQ function is on/off, in higher layer signaling, as information on whether or not HARQ-ACK transmission is possible.

For example, as illustrated in FIG. 3, in period A, when the user terminal receives information to the effect that the HARQ function is on, in higher layer signaling, the user terminal feeds back an HARQ-ACK in the PUCCH or the PUSCH. As for the method of sending HARQ-ACK feedback, a method of existing LTE systems (feedback timing, etc.) may be used, or a different method may be used.

On the other hand, in period B, when the user terminal receives information to the effect that the HARQ function is off, in higher layer signaling, the user terminal does not feed back (that is, skips) an HARQ-ACK in the PUCCH or the PUSCH. In this case, the radio base station does not receive an HARQ-ACK from the user terminal, and therefore the radio base station does not retransmit data and transmits new data in each subframe. The user terminal performs the receiving operation (for example, demodulation and/or other processes) on the assumption that new data is transmitted from the radio base station.

In this way, it is possible to semi-statically control whether or not the user terminal can transmit HARQ-ACKs by commanding the user terminal to turn on/off the HARQ function by using higher layer signaling.

<When Using Whether or Not PUCCH Resources are Allocated>

As another example of the first example, on/off of the HARQ function in the user terminal may be controlled depending on whether or not PUCCH resources are configured by using higher layer signaling. Hereinafter, a case where the user terminal determines on/off of the HARQ function based on whether or not PUCCH resources are allocated by higher layer signaling will be described.

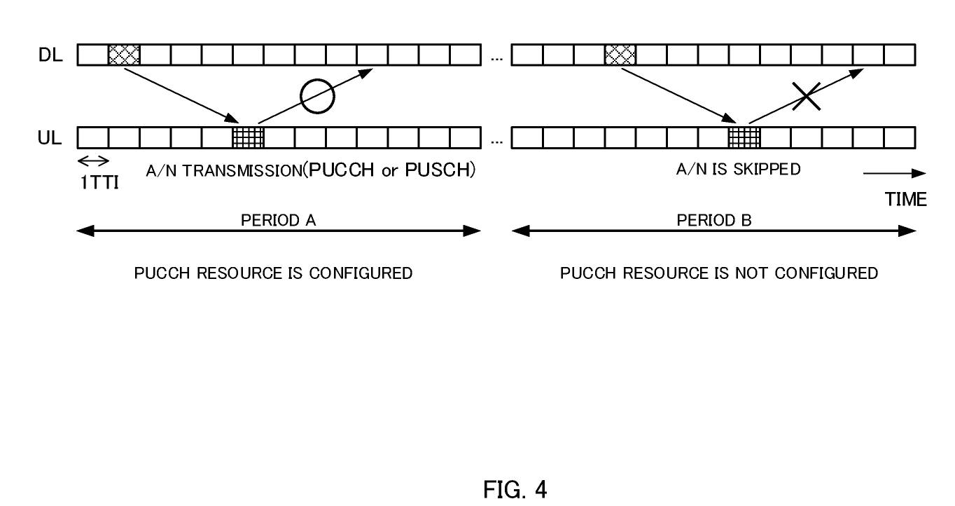

In the example of FIG. 4, whether or not PUCCH resources are allocated is used as information on whether or not HARQ-ACK transmission is possible. The user terminal exerts control so that an HARQ-ACK is transmitted when PUCCH resources are allocated and no HARQ-ACK is transmitted when no PUCCH resources are allocated. As for the allocation (configuration) of a PUCCH resource to the user terminal, a specific PUCCH resource may be allocated, or a plurality of candidate PUCCH resources (for example, ARI: ACK/NACK Resource Indicator) may be allocated.

For example, in FIG. 4, in period A, PUCCH resources are allocated to a user terminal by higher layer signaling, and, in period B, PUCCH resources are not allocated by higher layer signaling. In period A, the user terminal determines to turn on the HARQ function and feeds back an HARQ-ACK in the PUCCH or the PUSCH. For example, the user terminal uses the PUCCH resources configured by higher layer signaling when there is no uplink data to be transmitted (UL transmission command), and, when there is uplink data to be transmitted, the user terminal transmits the HARQ-ACK by using the PUSCH.

On the other hand, in period B, the user terminal determines to turn off the HARQ function, and controls, at least, not to send (that is, to skip) HARQ feedback using the PUCCH. As described above, it is possible to implicitly report whether or not an HARQ-ACK can be transmitted by controlling whether or not HARQ-ACKs can be transmitted using the PUCCH in the user terminal based on whether or not PUCCH resources are allocated. As a result, information for use solely for on/off control of HARQ-ACK in the user terminal can be made unnecessary.

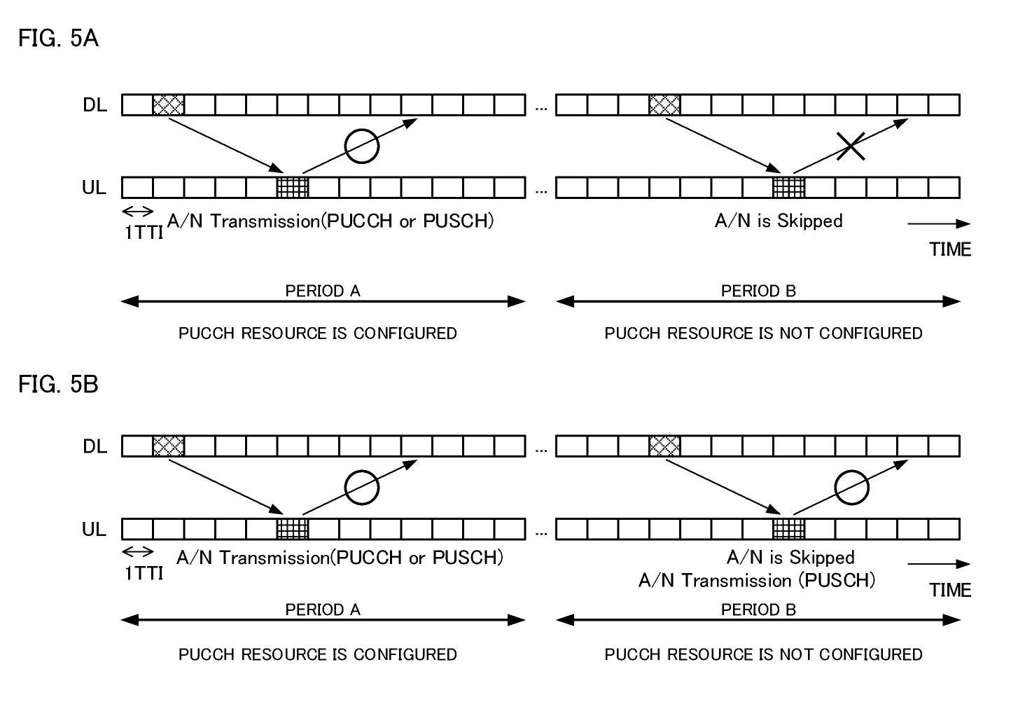

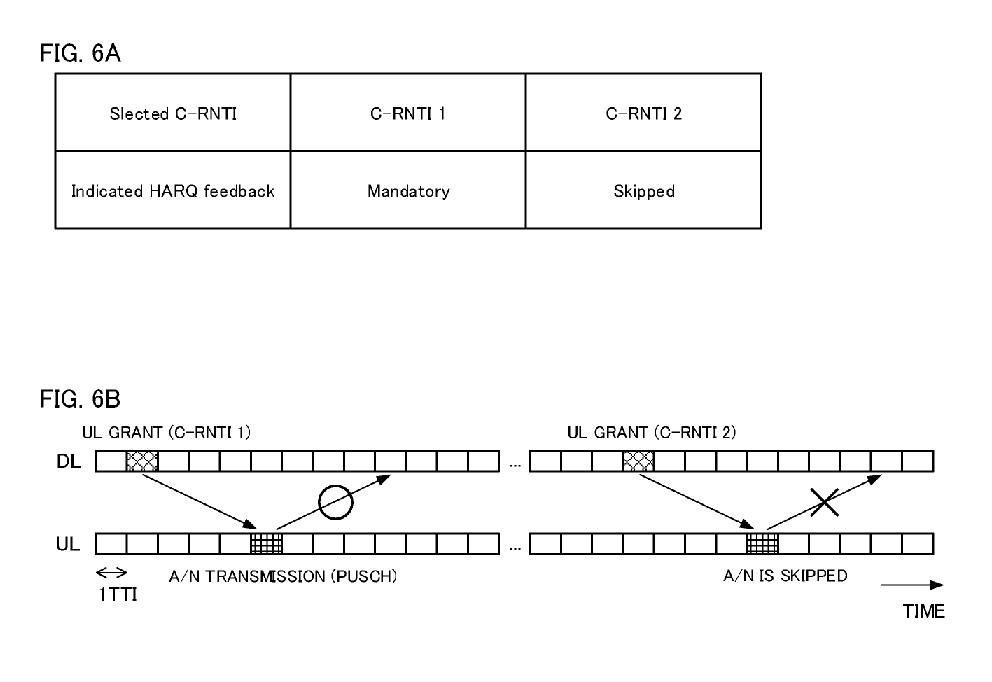

Note that HARQ-ACK transmission to use the PUSCH may be performed depending on whether or not HARQ-ACKs can be transmitted using the PUCCH (see FIG. 5A), or may be controlled independently of HARQ-ACK transmission using the PUCCH (see FIGS. 5B and 6).

As illustrated in FIG. 5A, when PUCCH resources are not allocated by higher layer signaling, the user terminal determines to turn off the HARQ function even if the PUSCH is scheduled. Then, the user terminal exerts control so that HARQ feedback is not sent (that is, skipped) in the PUSCH, as with the PUCCH. When PUCCH resources are allocated, the user terminal judges that the HARQ function is turned on, and feeds back an HARQ in the PUCCH or the PUSCH in the same manner as in the example illustrated in FIG. 4.

Further, as illustrated in FIG. 5B, when PUCCH resources are not allocated by higher layer signaling, the user terminal exerts control so as to send HARQ feedback in the PUSCH when the PUSCH is scheduled. In this way, it is also possible to control whether or not HARQ-ACKs can be transmitted using the PUSCH depending on whether or not the PUSCH is scheduled.

Furthermore, when no PUCCH resources are allocated by higher layer signaling received by the user terminal, it is also possible to control whether or not HARQ-ACKs can be transmitted by using the PUSCH based on downlink control information in which UL allocation command (UL grant) is included (configured). For example, a predetermined bit field configured in UL grants can be used as information on whether or not HARQ-ACK transmission is possible.

To be more specific, when the predetermined bit field is “1,” the user terminal determines to turn on the HARQ function and exerts control so as to feed back an HARQ in the PUSCH. On the other hand, if the predetermined bit field is “0,” the user terminal determines to turn off the HARQ function, and exerts control so as not to send (that is, to skip) HARQ feedback in the PUSCH. In this manner, it is also possible to explicitly control whether or not HARQ-ACKs can be transmitted, by using a predetermined bit field.

Alternatively, the user terminal can control whether or not HARQ-ACKs can be transmitted using the PUSCH based on cell-radio network temporary identifiers (C-RNTI) applied to UL grants. For example, as illustrated in FIG. 6A, two different C-RNTIs can be applied to UL grants, and a command to turn on or off the HARQ function is configured in association with each C-RNTI.

As illustrated in FIG. 6B, when receiving a UL grant to which C-RNTI 1 is applied, the user terminal determines to turn on the HARQ function and exerts control to feed back an HARQ in the PUSCH. On the other hand, when receiving a UL grant to which C-RNTI 2 is applied, the user terminal determines to turn off the HARQ function and controls not to send (that is, to skip) HARQ feedback in the PUSCH. In this way, it is also possible to implicitly control whether or not HARQ-ACKs can be transmitted, based on C-RNTIs that are applied to UL grants.

As described above, in the first example, the user terminal can, if necessary, control whether or not HARQ-ACKs can be transmitted, by receiving information on whether or not HARQ-ACK transmission is possible, via higher layer signaling. Therefore, by transmitting delivery acknowledgment signals only when necessary, the user terminal can reduce the overhead. In addition, it is also possible to control whether or not HARQ-ACKs can be transmitted using at least the PUCCH, by using higher layer signaling, and to control whether or not HARQ-ACKs can be transmitted using the PUSCH, by using UL grants.

### Second Example

In the first example, the case where the user terminal controls whether or not HARQ-ACKs can be transmitted based at least on information reported by higher layer signaling has been described. By contrast with this, in a second example, a case will be described where the user terminal controls whether or not HARQ-ACKs can be transmitted based at least on information reported in downlink control information (DCI).

Hereinafter, an example of a case in which on/off of the HARQ function is reported to the user terminal by using downlink control information will be described.

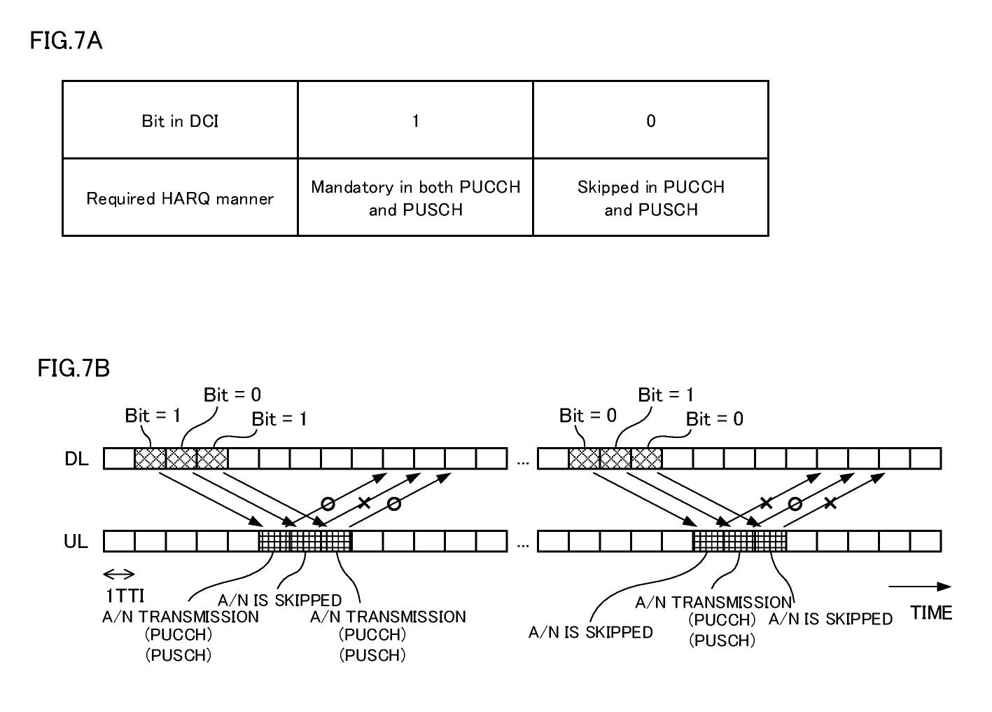

FIG. 7 illustrates an example of a case where a predetermined bit field configured in DL assignments is used as information on whether or not HARQ-ACK transmission is possible. To be more specific, a predetermined bit field configured in DL assignments is newly defined as a bit field for specifying whether or not HARQ-ACKs can be transmitted (see FIG. 7A). In this case, it is also possible to control whether or not HARQ-ACKs can be transmitted using the PUCCH and the PUSCH based on downlink control information (DL assignment), in which DL allocation command is included (configured).

For example, when the predetermined bit field is “1,” the user terminal determines to turn on the HARQ function and exerts control so as to feedback an HARQ in the PUCCH and the PUSCH (see FIG. 7B). On the other hand, when the predetermined bit field is “0,” the user terminal determines to turn off the HARQ function and exerts control so as not to send (that is, to skip) HARQ feedback in the PUCCH or in the PUSCH. In this manner, it is also possible to explicitly report whether or not HARQ-ACKs can be transmitted, by using a predetermined bit field.

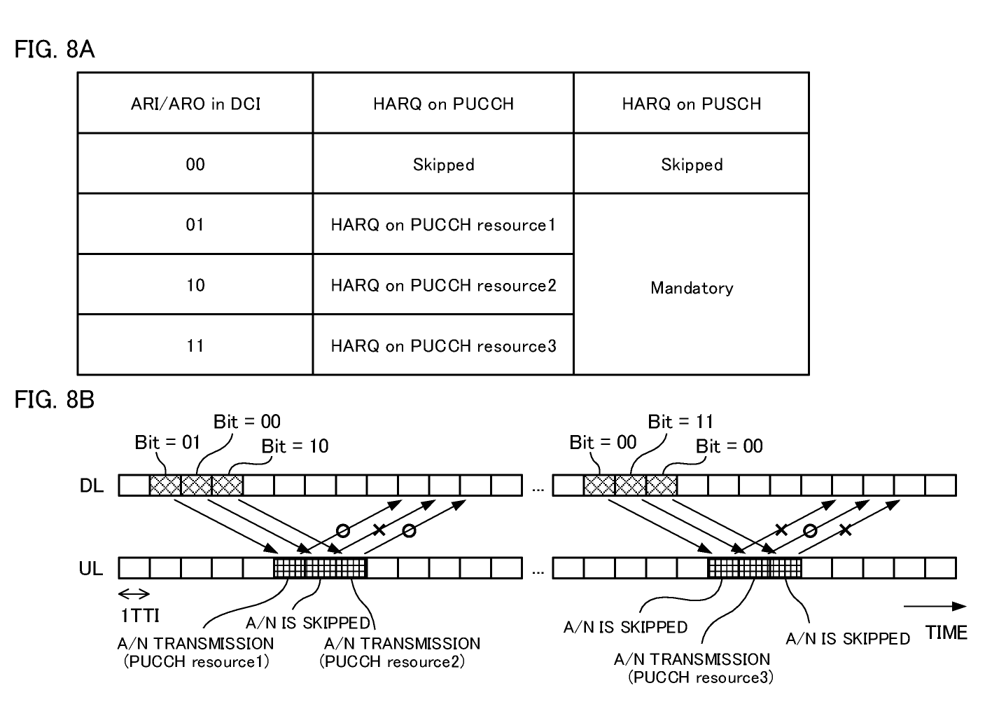

Further, as another example of the second example, it is also possible to use the bit field for specifying PUCCH resources, configured in DL assignments, as information on whether or not HARQ-ACK transmission is possible (see FIG. 8A). In other words, in FIG. 8, it is possible to control whether or not HARQ-ACKs can be transmitted using the PUCCH and the PUSCH based on downlink control information (DL assignment), in which DL allocation command is included (configured). As for the allocation (configuration) of PUCCH resources to the user terminal, specific PUCCH resources may be allocated, or a plurality of candidate PUCCH resources (for example, ARI, ARO (ACK/NACK Resource Offset), and so on) may be allocated.

For example, in the ARI/ARO in the downlink control information, if the predetermined bit field is “00,” the user terminal determines to turn off the HARQ function and controls not to send (that is, to skip) HARQ feedback in the PUCCH and the PUSCH (see FIG. 8B). Also, when the predetermined bit field is “01,” the user terminal determines to turn on the HARQ function. Then, the user terminal controls HARQ feedback to be sent in PUCCH resource 1, and, furthermore, controls HARQ feedback to be sent in the PUSCH. Also, when the predetermined bit field is “10,” the user terminal determines to turn on the HARQ function. Then, the user terminal controls HARQ feedback to be sent in PUCCH resource 2, and, furthermore, controls HARQ feedback to be sent in the PUSCH. Further, when the predetermined bit field is “11,” the user terminal determines to turn on the HARQ function. Then, the user terminal controls HARQ feedback to be sent in PUCCH resource 3, and, furthermore, controls HARQ feedback to be sent in the PUSCH. In this manner, it is also possible to implicitly report whether or not HARQ-ACKs can be transmitted, by using a PUCCH-resource specifying bit field that is configured in DL assignments.

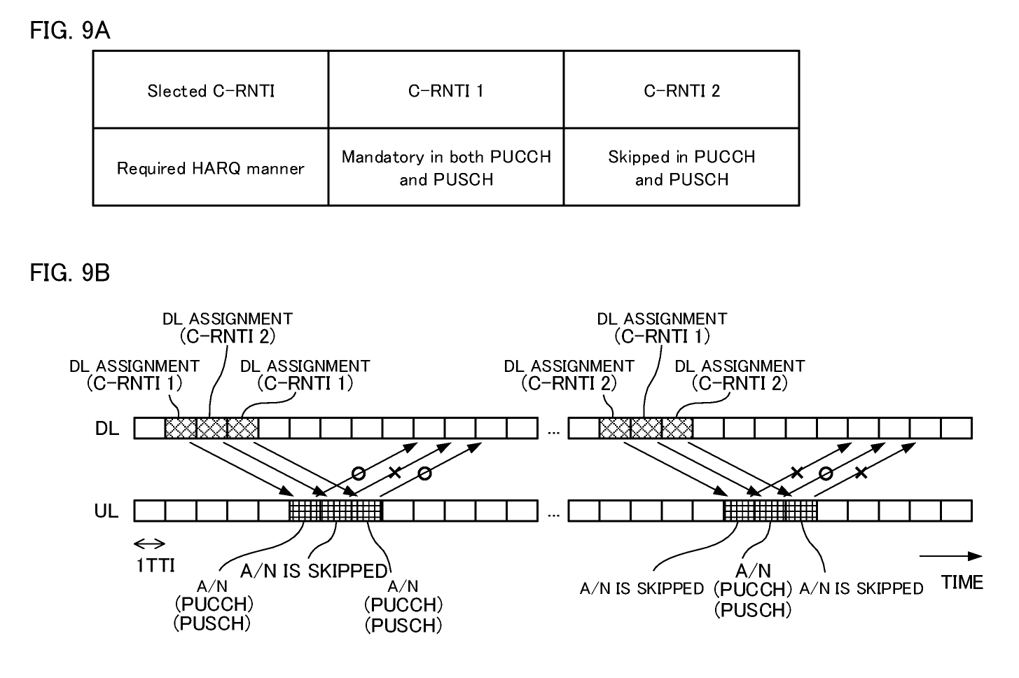

Furthermore, as another example of the second example, the user terminal can control whether or not HARQ-ACK can be transmitted using the PUCCH and the PUSCH based on C-RNTIs applied to DL assignments. For example, as illustrated in FIG. 9A, two different C-RNTIs are applied to DL assignments, and a command to turn on or off the HARQ function is configured in association with each C-RNTI.

Upon receiving a DL assignment to which C-RNTI 1 is applied, the user terminal determines to turn on the HARQ function and exerts control to feed back an HARQ in the PUCCH and the PUSCH (see FIG. 9B). On the other hand, when receiving a DL assignment to which C-RNTI 2 is applied, the user terminal determines to turn off the HARQ function and controls not to send (that is, to skip) HARQ feedback in the PUSCH. In this manner, it is also possible to implicitly report whether or not HARQ-ACKs can be transmitted, by using C-RNTIs applied to DL assignments.

As described above, also in the second example, the user terminal can control whether or not HARQ-ACKs can be transmitted based on information on whether or not HARQ-ACK transmission is possible. Therefore, by transmitting delivery acknowledgment signals only when necessary, the user terminal can reduce the overhead.

As another example, a configuration may be possible in which whether or not HARQ-ACKs can be transmitted is controlled depending on the presence or absence of UE capability. For example, when the user terminal does not have the capability (UE capability) for controlling whether or not HARQ-ACKs can be transmitted, the radio base station determines that the user terminal should always turn on the HARQ function and performs control (for example, signal transmission).

On the other hand, when the user terminal has the capability for controlling whether or not HARQ-ACKs can be transmitted, the radio base station reports information on whether or not HARQ-ACK transmission is possible, to the user terminal, depending on the communication environment or the like. The user terminal can control on/off of the HARQ function based on the information on whether or not HARQ-ACKs can be transmitted, reported from the radio base station.

(Radio Communication System)

Now, the structure of the radio communication system according to an embodiment of the present invention will be described below. In this radio communication system, the radio communication methods according to the above-described embodiments are employed. Here, although NB-IoT UEs (NB-IoT) terminals will be explained as exemplary user terminals that are limited to using a narrow band as the band for their use, the present invention is by no means limited to this.

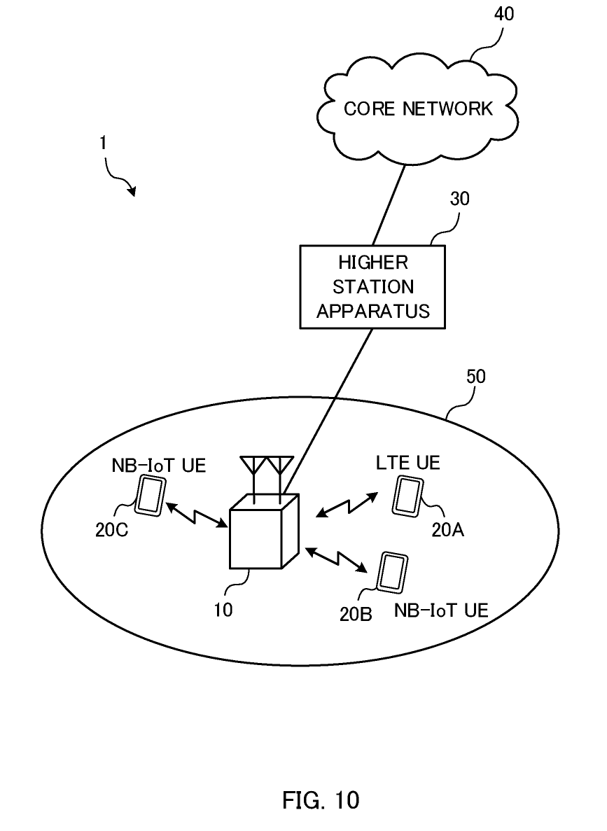

FIG. 10 is a diagram to illustrate a schematic structure of the radio communication system according to an embodiment of the present invention. The radio communication system 1 illustrated in FIG. 10 is an example of employing an LTE system in the network domain of a machine communication system. The radio communication system 1 can adopt carrier aggregation (CA) and/or dual connectivity (DC) to group a plurality of fundamental frequency blocks (component carriers) into one, where the system bandwidth of an LTE system constitutes one unit. Also, although it is assumed that the system band of this LTE system is configured to be minimum 1.4 MHz and maximum 20 MHz in both the downlink and the uplink, this configuration is by no means limiting.

Note that the radio communication system 1 may be referred to as “SUPER 3G,” “LTE-A,” (LTE-Advanced), “IMT-Advanced,” “4G” (4th generation mobile communication system), “5G” (5th generation mobile communication system), “FRA” (Future Radio Access) and so on.

The radio communication system 1 is comprised of a radio base station 10 and a plurality of user terminals 20A, 20B and 20C that are connected with the radio base station 10. The radio base station 10 is connected with a higher station apparatus 30, and connected with a core network 40 via the higher station apparatus 30. Note that the higher station apparatus 30 may be, for example, an access gateway apparatus, a radio network controller (RNC), a mobility management entity (MME) and so on, but is by no means limited to these.

A plurality of user terminals 20 (20A to 20C) can communicate with the radio base station 10 in a cell 50. For example, the user terminal 20A is a user terminal that supports LTE (up to Rel-10) or LTE-Advanced (including Rel-10 and later versions) (hereinafter referred to as an “LTE terminal”), and the other user terminals 20B and 20C are NB-IoT terminals that serve as communication devices in machine communication systems. Hereinafter the user terminals 20A, 20B and 20C will be simply referred to as “user terminals 20,” unless specified otherwise.

The NB-IoT terminals 20B and 20C are terminals that are limited to using a narrow band (for example, 200 kHz), which is narrower than the minimum system bandwidth supported in existing LTE system, as the band for their use. Note that the NB-IoT terminals 20B and 20C are terminals that support various communication schemes including LTE and LTE-A, and are by no means limited to stationary communication terminals such electric meters, gas meters, vending machines and so on, and can be mobile communication terminals such as vehicles. Furthermore, the user terminals 20 may communicate with other user terminals 20 directly, or communicate with other user terminals 20 via the radio base station 10.

In the radio communication system 1, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency band into a plurality of narrow frequency bands (subcarriers) and mapping data to each subcarrier. SC-FDMA is a single-carrier communication scheme to mitigate interference between terminals by dividing the system band into bands formed with one or continuous resource blocks per terminal, and allowing a plurality of terminals to use mutually different bands. Note that the uplink and downlink radio access schemes are by no means limited to the combination of these.

In the radio communication system 1, a downlink shared channel (PDSCH: Physical Downlink Shared CHannel), which is used by each user terminal 20 on a shared basis, a broadcast channel (PBCH: Physical Broadcast CHannel), downlink L1/L2 control channels and so on are used as downlink channels. User data, higher layer control information and predetermined SIBs (System Information Blocks) are communicated in the PDSCH. Also, the MIB (Master Information Blocks) is communicated in the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI) including PDSCH and PUSCH scheduling information is communicated by the PDCCH. The number of OFDM symbols to use for the PDCCH is communicated by the PCFICH. HARQ delivery acknowledgement signals (ACKs/NACKs) in response to the PUSCH are communicated by the PHICH. The EPDCCH is frequency-division-multiplexed with the PDSCH and used to communicate DCI and so on, like the PDCCH.

In the radio communication system 1, an uplink shared channel (PUSCH: Physical Uplink Shared CHannel), which is used by each user terminal 20 on a shared basis, an uplink control channel (PUCCH: Physical Uplink Control CHannel), a random access channel (PRACH: Physical Random Access CHannel) and so on are used as uplink channels. The PUSCH may be referred to as an uplink data channel. User data and higher layer control information are communicated by the PUSCH. Also, downlink radio quality information (CQI: Channel Quality Indicator), delivery acknowledgment information (ACKs/NACKs) and so on are communicated by the PUCCH. By means of the PRACH, random access preambles for establishing connections with cells are communicated.

The channels for MTC terminals/NB-IoT terminals may be represented by affixing an “M,” which stands for MTC, or an “N,” which stands for NB-IoT, or an “NB,” and, for example, an EPDCCH, a PDSCH, a PUCCH and a PUSCH for MTC terminals/NB-IoT terminals may be referred to as an “MPDCCH,” an “MPDCCH,” a “MPUCCH,” and an “MPUSCH,” respectively.

In the radio communication system 1, the cell-specific reference signal (CRS: Cell-specific Reference Signal), the channel state information reference signal (CSI-RS: Channel State Information-Reference Signal), the demodulation reference signal (DMRS: DeModulation Reference Signal), the positioning reference signal (PRS: Positioning Reference Signal) and so on are communicated as downlink reference signals. Also, in the radio communication system 1, the measurement reference signal (SRS: Sounding Reference Signal), the demodulation reference signal (DMRS) and so on are communicated as uplink reference signals. Note that, DMRSs may be referred to as “user terminal-specific reference signals” (UE-specific Reference Signals). Also, the reference signals to be communicated are by no means limited to these.

<Radio Base Station>

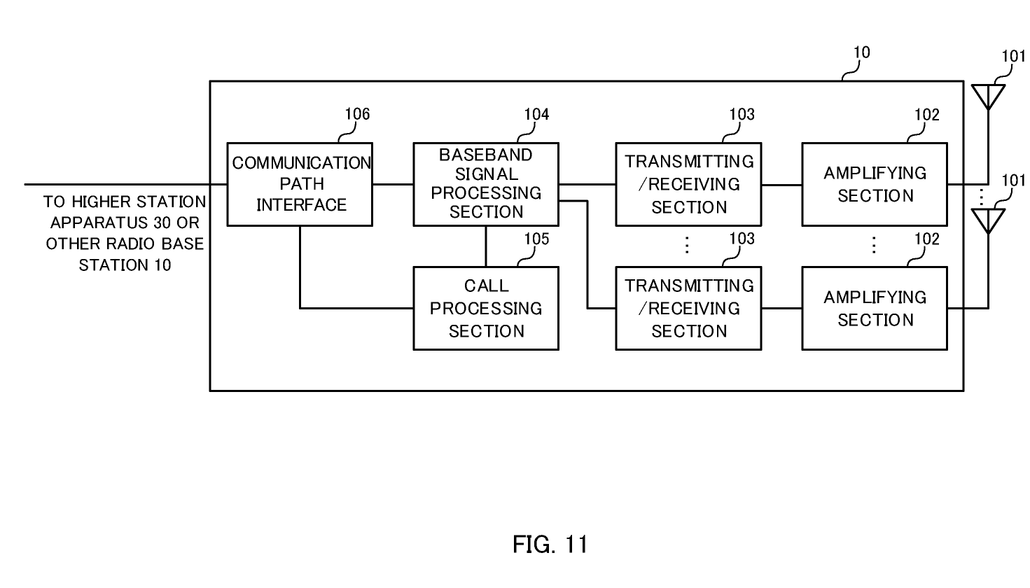

FIG. 11 is a diagram to illustrate an example of an overall structure of a radio base station according to one embodiment of the present invention. A radio base station 10 has a plurality of transmitting/receiving antennas 101, amplifying sections 102, transmitting/receiving sections 103, a baseband signal processing section 104, a call processing section 105 and a communication path interface 106. Note that the transmitting/receiving sections 103 are comprised of transmitting sections and receiving sections.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Baseband signals that are pre-coded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101.

The transmitting/receiving sections (receiving sections) 103 receive HARQ-ACKs transmitted from the user terminals. In addition, the transmitting/receiving section (transmitting sections) 103 can transmit information on whether or not delivery acknowledgement signals can be transmitted to the user terminals by using L1/L2 control signaling (for example, downlink control information) or higher layer signaling (for example, RRC signaling, etc.). For the transmitting/receiving sections 103, transmitters/receivers, transmitting/receiving circuits or transmitting/receiving devices that can be described based on common understanding of the technical field to which the present invention pertains can be used. Note that a transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10 and manages the radio resources.

The communication path interface section 106 transmits and receives signals to and from the higher station apparatus 30 via a pre-determined interface. Also, the communication path interface 106 may transmit and/or receive signals (backhaul signaling) with other radio base stations 10 via an inter-base station interface (for example, an interface in compliance with the CPRI (Common Public Radio Interface), such as optical fiber, the X2 interface, etc.).

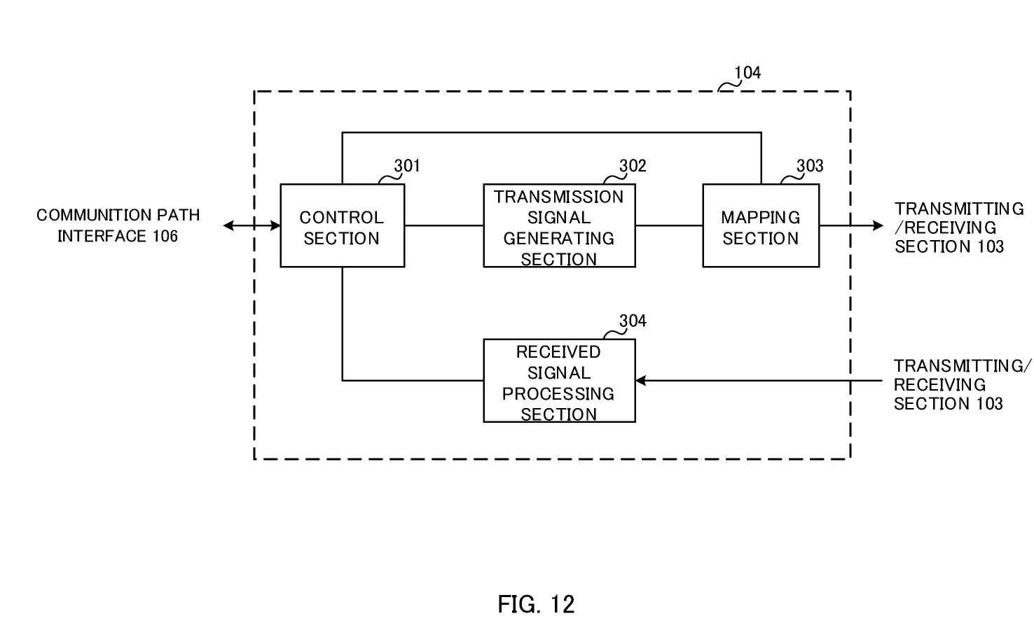

FIG. 12 is a diagram to illustrate an example of a functional structure of a radio base station according to the present embodiment. Note that, although FIG. 12 primarily illustrates functional blocks that pertain to characteristic parts of the present embodiment, the radio base station 10 has other functional blocks that are necessary for radio communication as well. As illustrated in FIG. 12A, the baseband signal processing section 104 has a control section (scheduler) 301, a transmission signal generating section (generation section) 302, a mapping section 303 and a received signal processing section 304.

The control section (scheduler) 301 controls the scheduling (for example, resource allocation) of downlink data signals that are transmitted in the PDSCH and downlink control signals that are communicated in the PDCCH and/or the EPDCCH. Also, the control section 301 controls the scheduling of system information, synchronization signals, paging information, CRSs (Cell-specific Reference Signals), CSI-RSs (Channel State Information Reference Signals) and so on. Furthermore, the control section 301 also controls the scheduling of uplink reference signals, uplink data signals that are transmitted in the PUSCH, and uplink control signals that are transmitted in the PUCCH and/or the PUSCH.

The control section 301 controls the retransmission of downlink data/new data transmission based on a delivery acknowledgement signals (HARQ-ACKs) fed back from the user terminals. Note that, for the control section 301, a controller, a control circuit or a control device that can be described based on common understanding of the technical field to which the present invention pertains can be used.

The transmission signal generating section 302 generates DL signals (downlink control signals, downlink data signals, downlink reference signals and so on) based on commands from the control section 301, and outputs these signals to the mapping section 303. To be more specific, the transmission signal generation section 302 generates downlink data signals (PDSCH) including user data and outputs this to the mapping section 303. Further, the transmission signal generation section 302 generates downlink control signals (PDCCH/EPDCCH) including DCI (UL grants, DL assignments, etc.), and outputs the generated control signals to the mapping section 303.

In addition, the transmission signal generation section 302 can generate downlink control information by using a part of the bit fields in existing downlink control information (DL assignments and/or UL grants). Further, the transmission signal generation section 302 generates downlink reference signals such as the CRS, the CSI-RS and so on, and outputs these to the mapping section 303. Note that, for the transmission signal generating section 302, a signal generator, a signal generating circuit or a signal generating device that can be described based on common understanding of the technical field to which the present invention pertains can be used.

The mapping section 303 maps the DL signals generated in the transmission signal generating section 302 to predetermined radio resources based on commands from the control section 301, and outputs these to the transmitting/receiving sections 103. For the mapping section 303, a mapper, a mapping circuit or a mapping device that can be described based on common understanding of the technical field to which the present invention pertains can be used.

The received signal processing section 304 performs the receiving process (for example, demapping, demodulation, etc.) of UL signals (HARQ-ACKs, the PUSCH and so on) transmitted from the user terminals 20. The processing results are output to the control section 301.

The receiving process section 304 can be constituted by a signal processor, a signal processing circuit or a signal processing device, and a measurer, a measurement circuit or a measurement device that can be described based on common understanding of the technical field to which the present invention pertains.

<User Terminal>

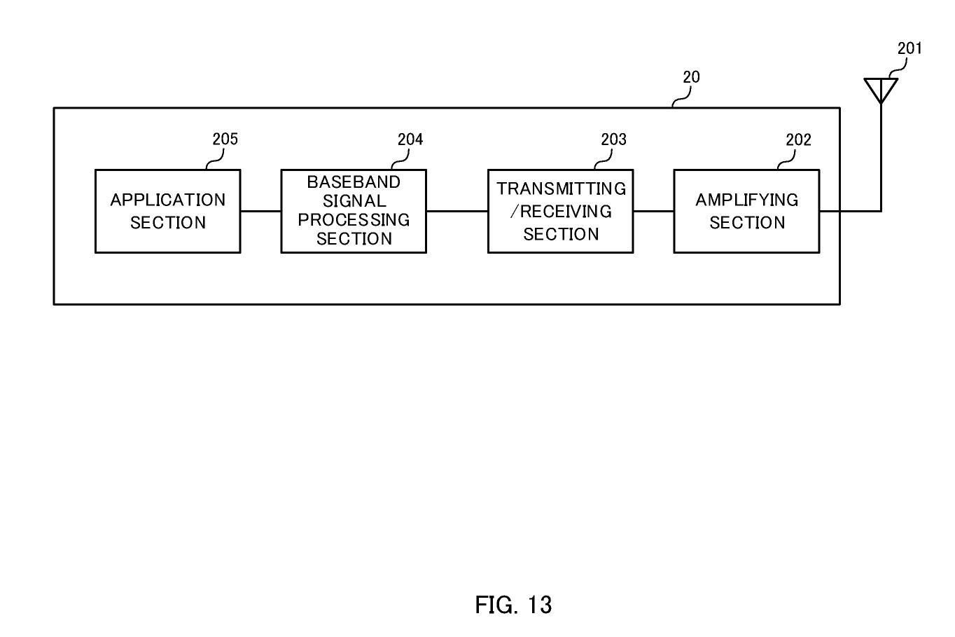

FIG. 13 is a diagram to illustrate an example of an overall structure of a user terminal according to an embodiment of the present invention. A user terminal 20 has a plurality of transmitting/receiving antennas 201 for MIMO communication, amplifying sections 202, transmitting/receiving sections 203, a baseband signal processing section 204 and an application section 205. Note that the transmitting/receiving sections 203 may be comprised of transmitting sections and receiving sections.

Radio frequency signals that are received in a plurality of transmitting/receiving antennas 201 are each amplified in the amplifying sections 202. Each transmitting/receiving section 203 receives the downlink signals amplified in the amplifying sections 202. The received signals are subjected to frequency conversion and converted into the baseband signal in the transmitting/receiving sections 203, and output to the baseband signal processing section 204.

The transmitting/receiving sections (receiving sections) 203 receive DL data signals (for example, the PDSCH), DL control signals (for example, UL grants, DL assignments, etc.) and the like. In addition, the transmitting/receiving sections (receiving sections) 203 can receive information on whether or not delivery acknowledgement signals can be transmitted. Further, the transmitting/receiving sections (receiving sections) 203 can receive information about the resources and/or signal sequences for transmitting delivery acknowledgment signals in existing downlink control information (for example, DL assignments).

In addition, the transmitting/receiving sections (receiving sections) 203 can receive information related to delivery acknowledgement signal transmission commands as downlink control information that is different from UL grants and DL assignments. In addition, the transmitting/receiving sections (receiving sections) 203 can receive information about the resources and/or signal sequences for transmitting delivery acknowledgment signals, in downlink control information in which the information related to delivery acknowledgement signal transmission commands is included. Note that, for the transmitting/receiving sections 203, transmitters/receivers, transmitting/receiving circuits or transmitting/receiving devices that can be described based on common understanding of the technical field to which the present invention pertains can be used.

The baseband signal processing section 204 performs receiving processes for the baseband signal that is input, including an FFT process, error correction decoding, a retransmission control receiving process and so on. Downlink user data is forwarded to the application section 205. The application section 205 performs processes related to higher layers above the physical layer and the MAC layer, and so on. Furthermore, in the downlink data, broadcast information is also forwarded to the application section 205.

Meanwhile, uplink user data is input from the application section 205 to the baseband signal processing section 204. The baseband signal processing section 204 performs a retransmission control transmission process (for example, an HARQ transmission process) , channel coding, pre-coding, a discrete Fourier transform (DFT) process, an IFFT process and so on, and the result is forwarded to each transmitting/receiving section 203. The baseband signal that is output from the baseband signal processing section 204 is converted into a radio frequency band in the transmitting/receiving section 203. The radio frequency signal that is subjected to frequency conversion in the transmitting/receiving section 203 is amplified in the amplifying section 202, and transmitted from the transmitting/receiving antenna 201.

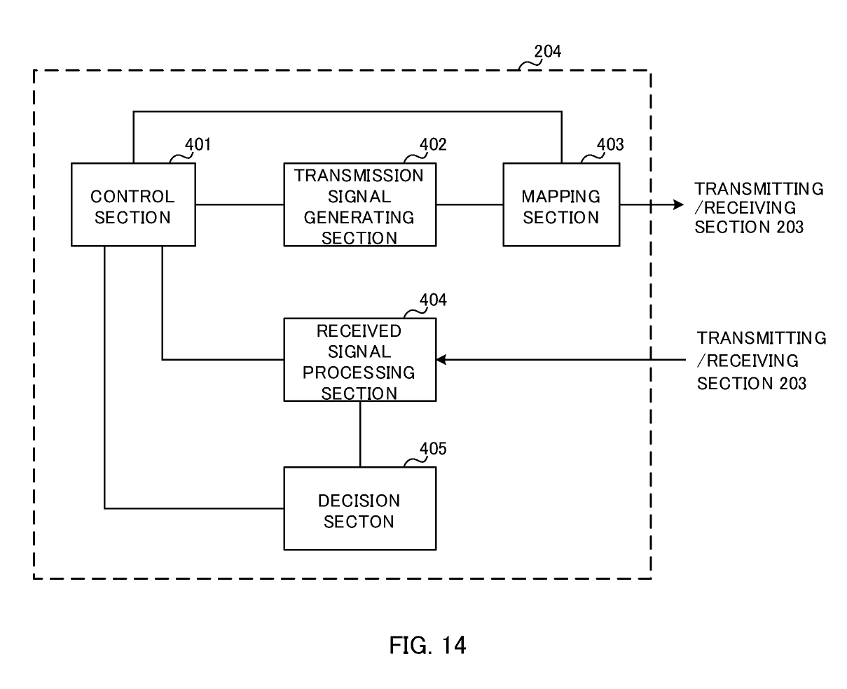

FIG. 14 is a diagram to illustrate an example of a functional structure of a user terminal according to the present embodiment. Note that, although FIG. 14 primarily illustrates functional blocks that pertain to characteristic parts of the present embodiment, the user terminal 20 has other functional blocks that are necessary for radio communication as well. As illustrated in FIG. 14, the baseband signal processing section 204 provided in the user terminal 20 has a control section 401, a transmission signal generating section 402, a mapping section 403, a received signal processing section 404 and a decision section 405. Note that a receiving section may be constituted by the received signal processing section 404 and the transmitting/receiving sections 203.

The control section 401 acquires the downlink control signals (signals transmitted in the PDCCH/EPDCCH) and downlink data signals (signals transmitted in the PDSCH) transmitted from the radio base station 10, from the received signal processing section 404. The control section 401 controls the generation of uplink control signals (for example, delivery acknowledgement signals (HARQ-ACKs) and so on) and uplink data signals based on the downlink control signals, the results of deciding whether or not re transmission control is necessary for the downlink data signals, and so on. To be more specific, the control section 401 can control the transmission signal generating section 402, the mapping section 403 and the received signal processing section 404.

The control section 401 can control whether or not delivery acknowledgement signals can be transmitted based on information on whether or not delivery acknowledgement signal transmission is possible. When no PUCCH resource is allocated by higher layer signaling, the control section 401 exerts control so as at least not to transmit delivery acknowledgment signals using the PUCCH (see FIG. 4). Also, in this case, the control section 401 exerts control so as not to transmit delivery acknowledgment signals using an uplink shared channel either (see FIG. 5A). In addition, when the PUSCH is scheduled, the control section 401 exerts control so that delivery acknowledgment signals are transmitted by using the PUSCH (see FIG. 5B). Furthermore, the control section 401 controls whether or not delivery acknowledgment signals can be transmitted based on a predetermined bit field configured in UL grants. In addition, the control section 401 controls whether or not delivery acknowledgment signals can be transmitted based on the cell-radio network temporary identifiers applied to UL grants (see FIG. 6).

Also, the control section 401 controls whether or not delivery acknowledgment signals can be transmitted based on the bit field configured in DL assignments to specify whether or not delivery acknowledgment signals can be transmitted (see FIG. 7). In addition, the control section 401 controls whether or not delivery acknowledgment signals can be transmitted based on the bit field for specifying PUCCH resources, configured in DL assignments (see FIG. 8). Further, the control section 401 controls whether or not delivery acknowledgment signals can be transmitted based on cell-specific radio network temporary identifiers applied to downlink assignments (see FIG. 9). Note that, for the control section 401, a controller, a control circuit or a control device that can be described based on common understanding of the technical field to which the present invention pertains can be used.

The transmission signal generating section 402 generates UL signals based on commands from the control section 401, and outputs these signals to the mapping section 403. For example, the transmission signal generating section 402 generates uplink control signals such as delivery acknowledgement signals (HARQ-ACKs), channel state information (CSI) and so on, based on commands from the control section 401.

Also, the transmission signal generating section 402 generates uplink data signals based on commands from the control section 401. For example, when a UL grant is included in a downlink control signal that is reported from the radio base station 10, the control section 401 commands the transmission signal generating section 402 to generate an uplink data signal. For the transmission signal generating section 402, a signal generator, a signal generating circuit or a signal generating device that can be described based on common understanding of the technical field to which the present invention pertains can be used.

The mapping section 403 maps the uplink signals (uplink control signals and/or uplink data) generated in the transmission signal generating section 402 to radio resources based on commands from the control section 401, and output the result to the transmitting/receiving sections 203. For the mapping section 403, mapper, a mapping circuit or a mapping device that can be described based on common understanding of the technical field to which the present invention pertains can be used.

The received signal processing section 404 performs receiving processes (for example, demapping, demodulation, decoding and so on) of DL signals (for example, downlink control signals transmitted from the radio base station, downlink data signals transmitted in the PDSCH, and so on). The received signal processing section 404 outputs the information received from the radio base station 10, to the control section 401 and the decision section 405. The received signal processing section 404 outputs, for example, broadcast information, system information, RRC signaling, DCI and so on, to the control section 401.

The received signal process section 404 can be constituted by a signal processor, a signal processing circuit or a signal processing device, and a measurer, a measurement circuit or a measurement device that can be described based on common understanding of the technical field to which the present invention pertains. Also, the received signal processing section 404 can constitute the receiving section according to the present invention.

The decision section 405 makes retransmission control decisions (ACKs/NACKs) based on the decoding results in the received signal processing section 404, and, furthermore, outputs the results to the control section 401. If downlink signals (PDSCH) are transmitted from a plurality CCs (for example, six or more CCs), the decision section 405 makes retransmission control decisions (ACKs/NACKs) for each CC, and outputs these decisions to the control section 401. The decision section 405 can be constituted by a decision circuit or a decision device that can be described based on common understanding of the technical field to which the present invention pertains.

(Hardware Structure)

Note that the block diagrams that have been used to describe the above embodiments illustrate blocks in functional units. These functional blocks (components) may be implemented in arbitrary combinations of hardware and/or software. Also, the means for implementing each functional block is not particularly limited. That is, each functional block may be implemented with one physically-integrated device, or may be implemented by connecting two physically-separate devices via radio or wire and using these multiple devices.

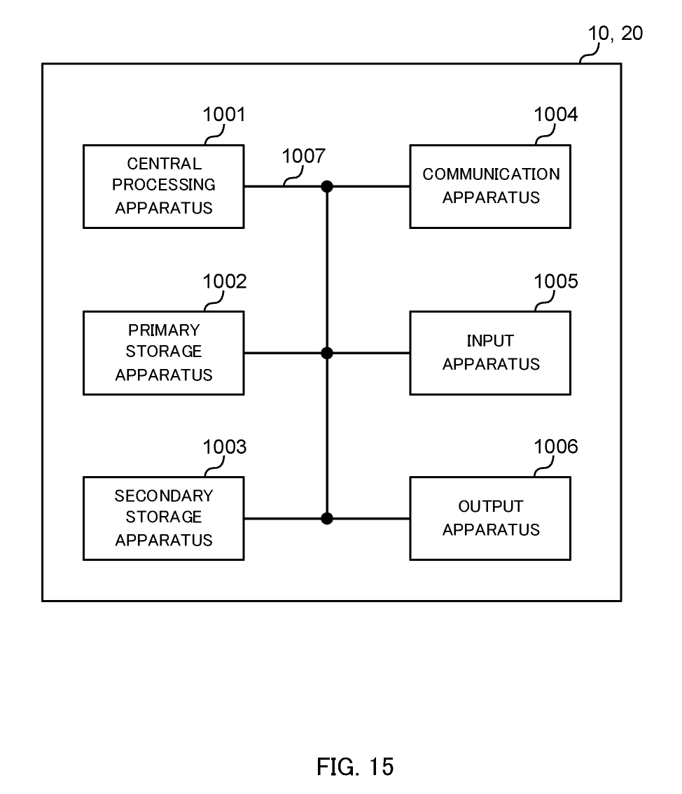

That is, a radio base station, a user terminal and so on according to an embodiment of the present invention may function as a computer that executes the processes of the radio communication method of the present invention. FIG. 15 is a diagram to illustrate an exemplary hardware structure of a radio base station and a user terminal according to an embodiment of the present invention. Physically, a radio base station 10 and a user terminal 20, which have been described above, may be formed as a computer apparatus that includes a central processing apparatus (processor) 1001, a primary storage apparatus (memory) 1002, a secondary storage apparatus 1003, a communication apparatus 1004, an input apparatus 1005, an output apparatus 1006 and a bus 1007. Note that, in the following description, the word “apparatus” may be replaced by “circuit,” “device,” “unit” and so on.

Each function of the radio base station 10 and user terminal 20 is implemented by reading predetermined software (programs) on hardware such as the central processing apparatus 1001, the primary storage apparatus 1002 and so on, and controlling the calculations in the central processing apparatus 1001, the communication in the communication apparatus 1004, and the reading and/or writing of data in the primary storage apparatus 1002 and the secondary storage apparatus 1003.

The central processing apparatus 1001 may control the whole computer by, for example, running an operating system. The central processing apparatus 1001 may be formed with a processor (CPU: Central Processing Unit) that includes a control apparatus, a calculation apparatus, a register, interfaces with peripheral apparatus, and so on. For example, the above-described baseband signal process section 104 (204), call processing section 105 and so on may be implemented by the central processing apparatus 1001.

Also, the central processing apparatus 1001 reads programs, software modules, data and so on from the secondary storage apparatus 1003 and/or the communication apparatus 1004, into the primary storage apparatus 1002, and executes various processes in accordance with these. As for the programs, programs to allow the computer to execute at least part of the operations of the above-described embodiments may be used. For example, the control section 401 of the user terminal 20 may be stored in the primary storage apparatus 1002 and implemented by a control program that runs on the central processing apparatus 1001, and other functional blocks may be implemented likewise.

The primary storage apparatus (memory) 1002 is a computer-readable recording medium, and may be constituted by, for example, at least one of a ROM (Read Only Memory), an EPROM (Erasable Programmable ROM), a RAM (Random Access Memory) and so on. The secondary storage apparatus 1003 is a computer-readable recording medium, and may be constituted by, for example, at least one of a flexible disk, an opto-magnetic disk, a CD-ROM (Compact Disc ROM), a hard disk drive and so on.

The communication apparatus 1004 is hardware (transmitting/receiving device) for allowing inter-computer communication by using wired and/or wireless networks, and may be referred to as, for example, a “network device,” a “network controller,” a “network card,” a “communication module” and so on. For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from the outside (for example, a keyboard, a mouse, etc.). The output apparatus 1006 is an output device for allowing sending output to the outside (for example, a display, a speaker, etc.). Note that the input apparatus 1005 and the output apparatus 1006 may be provided in an integrated structure (for example, a touch panel).

Also, the apparatuses, including the central processing apparatus 1001, the primary storage apparatus 1002 and so on, may be connected via a bus 1007 to communicate information with each other. The bus 1007 may be formed with a single bus, or may be formed with buses that vary between the apparatuses. Note that the hardware structure of the radio base station 10 and the user terminal 20 may be designed to include one or more of each apparatus illustrated in the drawings, or may be designed not to include part of the apparatuses.

For example, the radio base station 10 and the user terminal 20 may be structured to include hardware such as an ASIC (Application-Specific Integrated Circuit), a PLD (Programmable Logic Device), an FPGA (Field Programmable Gate Array) and so on, and part or all of the functional blocks may be implemented by the hardware.

Note that the terminology used in this description and the terminology that is needed to understand this description may be replaced by other terms that convey the same or similar meanings. For example, “channels” and/or “symbols” may be replaced by “signals” (or “signaling”). Also, “signals” may be “messages.” Furthermore, “component carriers” (CCs) may be referred to as “cells,” “frequency carriers,” “carrier frequencies” and so on.

Also, the information and parameters described in this description may be represented in absolute values or in relative values with respect to a pre-determined value, or may be represented in other information formats. For example, radio resources may be specified by predetermined indices.

The information, signals and/or others described in this description may be represented by using a variety of different technologies. For example, data, instructions, commands, information, signals, bits, symbols and chips, all of which may be referenced throughout the description, may be represented by voltages, currents, electromagnetic waves, magnetic fields or particles, optical fields or photons, or any combination of these.

Also, software and commands may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation and microwaves), these wired technologies and/or wireless technologies are also included in the definition of communication media.

The examples/embodiments illustrated in this description may be used individually or in combinations, and the mode of may be switched depending on the implementation. Also, a report of pre-determined information (for example, a report to the effect that “X holds”) does not necessarily have to be sent explicitly, and can be sent implicitly (by, for example, not reporting this piece of information).

Reporting of information is by no means limited to the examples/embodiments described in this description, and other methods may be used as well. For example, reporting of information may be implemented by using physical layer signaling (for example, DCI (Downlink Control Information) and UCI (Uplink Control Information)), higher layer signaling (for example, RRC (Radio Resource Control) signaling, broadcast information (the MIB (Master Information Block) and SIBs (System Information Blocks)) and MAC (Medium Access Control) signaling and so on), other signals or combinations of these. Also, RRC signaling may be referred to as “RRC messages,” and can be, for example, an RRC connection setup message, RRC connection reconfiguration message, and so on.

The examples/embodiments illustrated in this description may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other adequate systems, and/or next-generation systems that are enhanced based on these.

The order of processes, sequences, flowcharts and so on that have been used to describe the examples/embodiments herein may be re-ordered as long as inconsistencies do not arise. For example, although various methods have been illustrated in this description with various components of steps in exemplary orders, the specific orders that illustrated herein are by no means limiting.

Now, although the present invention has been described in detail above, it should be obvious to a person skilled in the art that the present invention is by no means limited to the embodiments described herein. For example, the above-described embodiments may be used individually or in combinations. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

The disclosure of Japanese Patent Application No. 2015-217987, filed on Nov. 5, 2015, including the specification, drawings and abstract, is incorporated herein by reference in its entirety.

1. A user terminal comprising:
a receiving section that receives a DL signal; and
a control section that controls transmission of a delivery acknowledgement signal in response to the DL signal, wherein:
the receiving section receives information on whether or not transmission of the delivery acknowledgement signal is possible in higher layer signaling and/or in downlink control information; and
the control section controls whether or not the delivery acknowledgement signal can be transmitted based on the information on whether or not transmission of the delivery acknowledgement signal is possible.

2. The user terminal according to claim 1, wherein, when no uplink control channel resource is allocated by higher layer signaling, the control section exerts control so that at least the delivery acknowledgement signal is not transmitted by using an uplink control channel.

3. The user terminal according to claim 2, wherein the control section exerts control so that the delivery acknowledgement signal is not transmitted by using an uplink shared channel either.

4. The user terminal according to claim 2, wherein, when an uplink shared channel is scheduled, the control section exerts control so that the delivery acknowledgement signal is transmitted by using the uplink shared channel.

5. The user terminal according to claim 2, wherein the control section controls whether or not the delivery acknowledgement signal can be transmitted based on a predetermined bit field configured in an uplink grant.

6. The user terminal according to claim 2, wherein the control section controls whether or not the delivery acknowledgement signal can be transmitted based on a cell radio network temporary identifier (C-RNTI) applied to an uplink grant.

7. The user terminal according to claim 1, wherein the control section controls whether or not the delivery acknowledgement signal can be transmitted based on a bit field for specifying whether or not the delivery acknowledgement signal can be transmitted, which is configured in a downlink assignment, or based on a bit field for specifying an uplink control channel resource, which is configured the downlink assignment.

8. The user terminal according to claim 1, wherein the control section controls whether or not the delivery acknowledgement signal can be transmitted based on a cell radio network temporary identifier applied to a downlink assignment.

9. A radio base station comprising:
a transmission section that transmits a DL signal to a user terminal; and
a receiving section that receives a delivery acknowledgement signal in response to the DL signal,
wherein the transmission section transmits information on whether or not transmission of the delivery acknowledgement signal is possible in higher layer signaling and/or in downlink control information.

10. A radio communication method for a user terminal that communicates with a radio base station, the radio communication method comprising the steps of:
a receiving section that receives a DL signal; and
a control section that controls transmission of a delivery acknowledgement signal in response to the DL signal, wherein:
the control section controls whether or not the delivery acknowledgement signal can be transmitted based on information on reported in higher layer signaling and/or in downlink control information.
